(19) United States
(12) Patent Application Publication
(10) Pub. No.: US 2011/0220619 A1
(43) Pub. Date: Sep. 15, 2011

(54) POSITIONAL MONITORING SYSTEMS AND METHODS FOR WELDING DEVICES

(75) Inventor: Peter Donald Mehn, Oshkosh, WI (US)

(73) Assignee: Illinois Tool Works Inc., Glenview, IL (US)

(21) Appl. No.: 13/041,205

(22) Filed: Mar. 4, 2011

Related U.S. Application Data
(60) Provisional application No. 61/312,526, filed on Mar. 10, 2010.

(51) Int. Cl. B23K 11/24; B23K 10/02; B23K 9/00

(52) U.S. Cl. 219/108; 219/121.48; 219/136

(57) ABSTRACT

Welding systems including a welding device adapted to be utilized in a welding operation to establish a welding arc and a position detection system adapted to measure a parameter indicative of a position of the welding device are provided. Such welding systems may also include a controller adapted to receive feedback from the position detection system regarding the position of the welding device in at least two axes and to selectively transition control of the welding system between a first set of operational parameters and a second set of operational parameters based on changes in the received feedback during a welding operation.

### CROSS REFERENCE TO RELATED APPLICATIONS

This application is a Non-Provisional patent application of U.S. Provisional Patent Application No. 61/312,526 entitled “Torch Attitude Sensor for Process Control”, filed Mar. 10, 2010, which is herein incorporated by reference.

### BACKGROUND

The invention relates generally to welding systems and, more particularly, to systems and methods for monitoring a position of a welding device during a welding operation.

Welding is a process that has become ubiquitous in various industries for a variety of types of applications. For example, welding is often performed in applications such as shipbuilding, aircraft repair, construction, and so forth. Such welding operations may require an operator to rotate a welding device, such as a welding torch, between a variety of positions to maintain the welding device in a suitable position for the weld being performed. For example, while many traditional welding operations can be performed on a horizontal surface, certain weld environments may require the weld operator to weld a workpiece located above the operator. In such applications, the welding device is rotated into an overhead position, which may require a different set of weld parameters than a previously performed horizontal or flat weld. Unfortunately, in many applications, the welding operator may have to return to the welding power source to change one or more weld parameters, such as the amperage level, when overhead or other “out of position” welding is necessary, thus decreasing overall productivity, particularly when position changes occur relatively frequently. Accordingly, there exists a need for improved welding systems that overcome such drawbacks of typical systems.

### BRIEF DESCRIPTION

In an exemplary embodiment, a welding system includes a welding power source comprising power conversion circuitry adapted to receive primary power and to convert the primary power to a weld power output for use in a welding operation. A position detection system includes at least one sensor adapted to measure a parameter of a welding device, such as a welding torch, indicative of a position of the welding device during the welding operation. The welding system also includes a controller communicatively coupled to the position detection system and adapted to receive feedback from the position detection system regarding the position of the welding device during the welding operation, to identify when the position of the welding device reaches a predefined transition point, and to control the welding power source to operate within a first set of weld parameters when the position of the welding device has not reached the predefined transition point and to operate within a second set of weld parameters when the position of the welding device reaches the predefined transition point.

In another embodiment, a welding system includes a welding device adapted to be utilized in a welding operation to establish a welding arc, and a position detection system adapted to measure a parameter indicative of a position of the welding device. The welding system also includes a controller adapted to receive feedback from the position detection system regarding the position of the welding device in at least two axes, and to selectively transition control of the welding system between a first set of operational parameters and a second set of operational parameters based on changes in the received feedback during a welding operation.

In another embodiment, a controller for a welding system is adapted to receive feedback regarding a position of a welding device and to resolve a position of the welding device in a coordinate system including at least two axes based on the received feedback. The controller is also adapted to monitor the position of the welding device in the coordinate system during a welding operation and to indicate to at least one of a welding power source and an operator when the position of the welding device reaches a predefined transition point.

### DRAWINGS

These and other features, aspects, and advantages of the present invention will become better understood when the following detailed description is read with reference to the accompanying drawings in which like characters represent like parts throughout the drawings, wherein:

FIG. 1 illustrates an exemplary welding system which powers, controls, and provides supplies to a welding operation in accordance with embodiments of the present invention;

FIG. 2 is a block diagram illustrating embodiments of internal components of the welder, the wire feeder, and the welding torch assembly of FIG. 1;

FIG. 3 illustrates an exemplary method that may be employed by a controller of the system of FIG. 1 to operate the illustrated sensor system in accordance with an embodiment of the present invention;

FIG. 4 illustrates an exemplary weld operation being performed in a multi-axis positional system in which the changing position of the welding torch is monitored during welding in accordance with an embodiment of the present invention;

FIG. 5 illustrates a plot of a resolved torch position having a predefined transition point at which a controller may switch between a first set of weld parameters and a second set of weld parameters in accordance with an embodiment of the present invention; and

FIG. 6 illustrates a control method that may be utilized by the controller in an exemplary welding system to monitor in-position and out-of-position welding in accordance with an embodiment of the present invention.

### DETAILED DESCRIPTION

As described in detail below, provided herein are embodiments of welding systems including position and control systems adapted to continuously determine a position of a welding device (e.g., welding torch, plasma torch, etc.) throughout a welding operation and to determine when the position of the welding device reaches a transition point. In some embodiments, the control system may be configured to alert an operator when the transition point is reached, for example, via an indicator (e.g., an illumination device) located on a control panel visible to the welding operator. Further, in certain embodiments, the control system may be adapted to transition between a first set of weld parameters and a second set of weld parameters when the position of the welding device is determined to have reached or exceeded the transition point.

For example, in one embodiment, the position detection system detects when the welding torch transitions between an in-position weld (e.g., a horizontal weld) and an out-of-position weld (e.g., an overhead weld), and the control system adjusts one or more weld parameters automatically upon detection of the positional transition. For further example, in such an embodiment, the control system may alter the amperage setting of a power source to produce approximately 15% less heat for an overhead welding operation than a comparable flat welding operation. That is, in some embodiments, the current setting of the welding operation may be reduced as appropriate for the given application when the welding device is rotated from a position suitable for a flat weld to a position suitable for an overhead weld. Similarly, the amperage may be increased or decreased, or other welding parameters may be altered by a suitable amount when the welding device transitions between an overhead welding position and a flat welding position.

It should be noted that the transition point, as used herein, may apply to any desired positional transition point, not necessarily limited to transitions between in-position and out-of-position welding. Further, although the embodiments described herein are discussed in the context of a gas metal arc welding (GMAW) system, features of the presently disclosed embodiments may be applied to other suitable systems as well. For example, certain embodiments may be applicable to stick welding operations, metal inert gas (MIG) welding operations, tungsten inert gas (TIG) welding operations, and so forth. For further example, presently disclosed position and control systems may be utilized in conjunction with plasma cutting systems to monitor the position of a plasma torch and/or to alter one or more parameters of a plasma cutting operation based on the torch position.

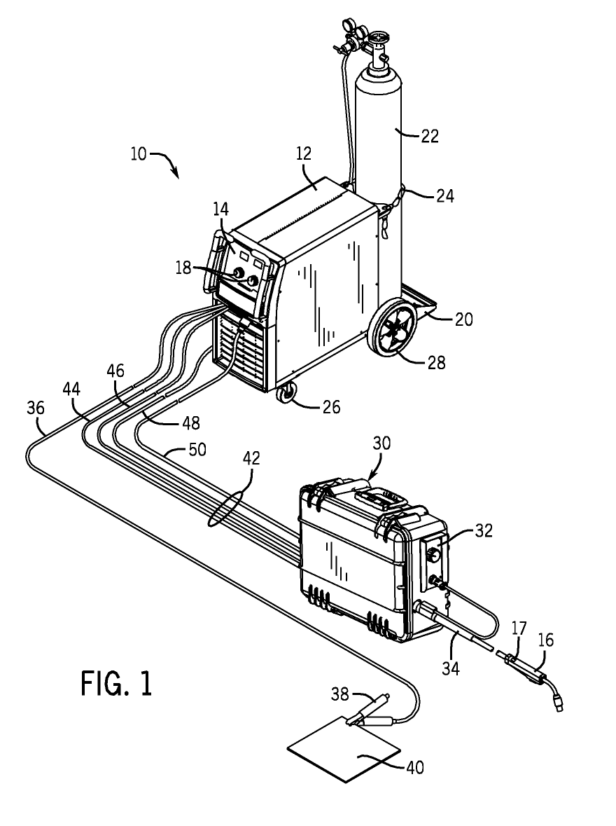

Turning now to the drawings, FIG. 1 illustrates an exemplary welding system 10 which powers, controls, and provides supplies to a welding operation. The welding system 10 includes a welder 12 having a control panel 14, through which a welding operator may control the supply of welding materials, such as gas flow, wire feed, and so forth, to a welding torch 16. The illustrated embodiment of the welding torch 16 includes an accelerometer 17 configured to measure a magnitude and direction of acceleration of the torch 16 during use. The accelerometer 17 is configured to communicate with a welding controller which may be located, for example, within the welder 12 and is configured to receive positional information from the accelerometer 17 and to monitor the motion of the torch 16 throughout a welding operation. It should be noted, however, that during the welding operation, there may be periods during which an arc is established and periods in which an arc is not established, and the welding controller may be configured to monitor the position of the torch regardless of the presence or absence of a welding arc. Still further, it should be noted that in some embodiments, the accelerometer 17 may be replaced with any other suitable positional detection device, such as a vision system located in the welding environment and configured to monitor torch movement.

The control panel 14 located on the welder 12 includes input or interface devices, such as knobs 18, which the operator may use to adjust welding parameters (e.g., voltage, current, etc.). That is, the operator interface 14 on the welder 12 enables data settings to be selected by the operator. The operator interface 14 may allow for selection of settings such as the weld process, the type of wire to be used, voltage and current settings, and so forth. In particular, the system is designed to allow for MIG welding with aluminum or other welding wire that is both pushed towards the torch 16 and pulled through the torch 16. However, in other embodiments, the welding system may be designed to allow for other types of wire feeds, such as pull only or push only systems.

In the illustrated embodiment, the welder 12 includes a tray 20 mounted on a back of the welder 12 and configured to support a gas cylinder 22 held in place with a chain 24. However, in other embodiments, the gas cylinder 22 may not be mounted on the welder 12 or may not be utilized in the welding system 10, for example, for gasless welding operations. In embodiments in which gas is desired for the welding operation, the gas cylinder 22 is the source of the gas that supplies the welding torch 16. Furthermore, the welder 12 may be portable via a set of smaller front wheels 26 and a set of larger back wheels 28, which enable the operator to move the welder 12 to the location of the weld or the welder 12 may be stationary as desired by the operator. Indeed, the illustrated welding system 10 is merely an example and may be modified as suitable for the type of welding or cutting operation being performed.

The illustrated welding system 10 also includes a suitcase wire feeder 30 that provides welding wire to the welding torch 16 for use in the welding operation. However, it should be noted that although the wire feeder 30 shown in the embodiment of FIG. 1 is a suitcase style feeder, in other embodiments, the wire feeder 30 may be any suitable wire feeding system, such as any of a variety of push-pull wire feeder systems, configured to utilize one or more motors to establish a wire feed to a welding torch. Indeed, embodiments of the present invention may be utilized in conjunction with bench style feeders and/or non-bench style feeders, such as boom mounted style feeders and portable, suitcase-style wire feeders.

In the illustrated embodiment, the wire feeder 30 includes a control panel 32 that allows the user to set one or more desired parameters. For example, in some embodiments, parameters of the wire feed (e.g., rate of wire feed, wire diameter, etc.) may be controlled via control panel 32 and/or interface module 17. For further example, in some embodiments, the control panel 32 on the wire feeder may include controls that duplicate one or more controls on the control panel 14 and enable the operator to alter one or more parameters of the welding operation. In such embodiments, the wire feeder 30 may communicate with the welding power source 12 to coordinate the welding and wire feeding operations.

Additionally, the wire feeder 30 may house a variety of internal components, such as a wire spool, a wire feed drive system, a motor, and so forth. In some embodiments, the welding power received from the welder 12 may be utilized by the internal components of the wire feeder 30 to power the gas flow and wire feed operations if desired for the given welding operation. As such, the wire feeder 30 may be used with any wire feeding process, such as gas operations (gas metal arc welding (GMAW)) or gasless operations (shielded metal arc welding (SMAW)). For example, the wire feeder 30 may be used in metal inert gas (MIG) welding or stick welding. Still further, in welding operations that do not utilize a wire feed, the wire feeder 30 may not be utilized.

Various cables couple the components of the welding system 10 together and facilitate the supply of welding materials to the welding torch 16. A first lead assembly 34 couples the welding torch 16 to the wire feeder 30. The first lead assembly 34 provides power, control signals, and welding consumables to the welding torch 16. For example, the first lead assembly 34 may include a control or data cable capable of conveying signals from the accelerometer 17 of the welding torch 16 to the welder 12 for control of parameters of the welding operation. That is, the accelerometer 17 may communicate information regarding the position of the welding torch 16 to a controller in the wire feeder and/or the welder 12 via lead assembly 34.

A second cable 36 couples the welder 12 to a work clamp 38 that connects to a workpiece 40 to complete the circuit between the welder 12 and the welding torch 16 during a welding operation. A bundle 42 of cables couples the welder 12 to the wire feeder 30 and provides weld materials for use in the welding operation. The bundle 42 includes a feeder power lead 44, a weld cable 46, a gas hose 48, and a weld control cable 50. Depending on the polarity of the welding process, the feeder power lead 44 may connect to the same weld terminal as the cable 36. It should be noted that the bundle 42 of cables may not be bundled together in some embodiments.

It should be noted that modifications to the exemplary welding system 10 of FIG. 1 may be made in accordance with aspects of the present invention. For example, the tray 20 may be eliminated from the welder 12, and the gas cylinder 22 may be located on an auxiliary support cart or in a location remote from the welding operation. Furthermore, as previously mentioned, although the illustrated embodiments are described in the context of a MIG welding process, one or more features of the invention may be utilized with a variety of other suitable welding systems and processes.

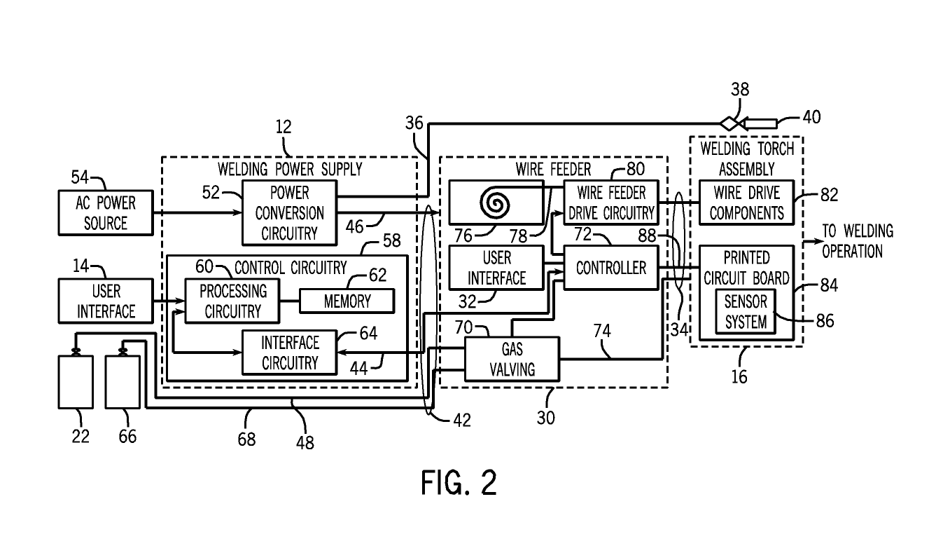

FIG. 2 is a block diagram illustrating internal components of the welder 12, the wire feeder 30, and the welding torch assembly 16. In the illustrated embodiment, the welder 12 includes power conversion circuitry 52 that receives input power from an alternating current power source 54 (e.g., the AC power grid, an engine/generator set, a battery, or a combination thereof), conditions the input power, and provides output power via lead 46 to the cable 34 to power one or more welding devices (e.g., welding torch assembly 16) in accordance with demands of the system 10. Accordingly, in some embodiments, the power conversion circuitry 52 may include circuit elements, such as transformers, rectifiers, switches, and so forth, capable of converting the AC input power to a direct current electrode positive (DCEP) or direct current electrode negative (DCEN) output, as dictated by the demands of the system 10. The lead cable 36 terminating in the clamp 38 couples the power conversion circuitry 52 to the workpiece 40 and closes the circuit between the power source 12, the workpiece 40, and the welding torch 16.

The weld power supply 12 also includes control circuitry 58 that is configured to receive and process a plurality of inputs regarding the performance and demands of the system 10. The control circuitry 58 includes processing circuitry 60 and memory 62. The memory 62 may include volatile or non-volatile memory, such as ROM, RAM, magnetic storage memory, optical storage memory, or a combination thereof. Furthermore, a variety of control parameters may be stored in the memory 62 along with code configured to provide a specific output (e.g., initiate wire feed, enable gas flow, etc.) during operation. The processing circuitry 60 may also receive one or more inputs from the user interface 14, through which the user may choose a process and input desired parameters (e.g., voltages, currents, particular pulsed or non-pulsed welding regimes, and so forth).

Based on such inputs received from the operator, the control circuitry 58 operates to control generation of welding power output that is applied to the welding wire for carrying out the desired welding operation, for example, via control signals transmitted to the power conversion circuitry 52. Based on such control commands, the power conversion circuitry 52 is adapted to create the output power that will ultimately be applied to the welding wire at the torch 16. To this end, as noted above, various power conversion circuits may be employed, including choppers, boost circuitry, buck circuitry, inverters, converters, and so forth. Still further, in the embodiment of FIG. 2, the control circuitry 58 also includes interface circuitry 64 configured to interface with the electronics of the wire feeder 30 during operation. The interface circuitry 64 is coupled to the processing circuitry 60 as well as to components of the wire feeder 30. Further, the processing circuitry 60 provides control signals associated with the weld operation to the wire feeder 30 via cable 44 coupled to the interface circuitry 64.

As before, the welder 12 and the wire feeder 30 are coupled to one another via the bundle 42 of cables, and the welding torch assembly 16 is coupled to the wire feeder 30 via cable bundle 34. In the illustrated embodiment, gas tanks 22 and 66 are configured to supply shielding gases, such as argon, helium, carbon dioxide, and so forth, via hoses 48 and 68, respectively, for use in the welding operation. In the embodiment illustrated in FIG. 2, the gas enters gas valving 70 located in the wire feeder 30. The gas valving 70 communicates with controller 72 of the wire feeder 30 to determine the quantity and flow rate of the gas to output via gas conduit 74.

The wire feeder 30 also includes the user interface 32 that allows for information such as wire feed speeds, processes, selected currents, voltages or power levels, and so forth to be set on either the power supply 12, the wire feeder 30, or both. As such, the user interface 32 is coupled to the controller 72, which allows for wire feed speeds to be controlled in accordance with operator selections, and permits these settings to be fed back to the power supply 12 via the interface circuitry 64.

The wire feeder 30 also includes components for feeding wire to the welding torch 16 and thereby to the welding application, under the control of controller 72. For example, one or more spools 76 of welding wire 78 are housed in the wire feeder 30. Wire feeder drive circuitry 80 may be provided to unspool welding wire 78 from the spools 76 and to progressively feed the welding wire 78 to the torch 16. To that end, the wire feeder drive circuitry 80 may include components such as motors, rollers, and so forth, configured in a suitable way for establishing an appropriate wire feed. For example, in one embodiment, the drive circuitry 80 may include a feed motor that engages with feed rollers to push wire from the wire feeder 30 towards the torch 16. In practice, one of the rollers may be mechanically coupled to the feed motor and rotated by the motor to drive the wire from the wire feeder, while the mating roller is biased towards the wire to maintain good contact between the two rollers and the wire. Some systems may include multiple rollers of this type.

Power from the power supply 12 is applied to the fed wire, typically by means of the welding cable 46, in a conventional manner. During welding operations, the wire is advanced through the welding cable 34 towards the torch 16. Within the torch 16, additional wire drive components 82, such as an additional pull motor and an associated drive roller, may be provided. The pull motor may be regulated to provide the desired wire feed speed. For example, a trigger switch on the torch may provide a signal that is fed back to the wire feeder and then back to the power supply to enable the welding process to be started and stopped by the operator. That is, upon depression of the trigger switch, gas flow is begun, wire is advanced, power is applied to the welding cable and through the torch to the advancing welding wire.

In the illustrated embodiment, the welding torch assembly 16 also includes a printed circuit board (PCB) 84 including a sensor system 86. The printed circuit board 84 is coupled to the controller 72 of the wire feeder 30 via cable 88. During operation, the sensor system 86 is configured to measure one or more parameters of the welding torch 16 that are indicative of a position of the welding torch in the weld environment. To that end, the sensor system 86 may include one or more sensors (e.g., accelerometers) that measure the desired parameters continuously or at desired intervals throughout the weld operation. As the sensor system 86 acquires such data regarding the operational position of the welding torch 16, the positional data is communicated to the controller 72 in the wire feeder 30 via cable 88.

It should be noted that the sensor system 86 may be provided as an integral part of the welding torch assembly 16 in some embodiments. That is, the sensor system 86 may be integrated into the torch assembly 16, for example, during manufacturing of the torch. However, in other embodiments, the sensor system 86 may be provided as a retrofit kit that may enable existing torch assemblies with the positional monitoring described herein. To that end, such retrofit kits may be configured as wired or wireless devices capable of communicating with one or more controllers of the weld system. For example, in one embodiment of the retrofit kit, the sensor system may be configured to mount to the welding torch and be programmable to communicate with the desired controller (e.g., controller 72 located in the wire feeder).

In one embodiment, the controller 72 in the wire feeder 30 analyzes the received positional data to determine if and/or when the welding torch 16 reaches a predefined transition point. In certain embodiments, when the transition point has been reached, the controller 72 may communicate to the processing circuitry 60 in the welder 12 that the torch 16 has reached the transition point. In such embodiments, the processing circuitry 60 then determines one or more appropriate changes to the weld parameters (e.g., increase or decrease wire feed speed, change voltage level, etc.) and implements such changes. However, in an alternate embodiment, the controller 72 in the wire feeder 30 may identify and implement the necessary weld parameter changes. Indeed, a variety of arrangements may utilize the controller 72 and/or the processing circuitry 60 to identify that the torch 16 has reached the transition point and/or to alter parameters as necessary for the given application.

In the illustrated embodiment, the sensor system 86 provides feedback to the controller 72 and/or the processing circuitry 60 via a wired connection. However, it should be noted that in other embodiments, communication between components of the welding torch assembly (e.g., the sensor system, the wire drive components, etc.) and components of the welder 12 and/or the wire feeder 30 may occur via a wireless communication link. Indeed, any suitable method of conveying positional torch feedback to one or more controllers capable of altering weld parameters and/or alerting an operator to the presence of an error may be employed in presently contemplated embodiments, not limited to wired connections.

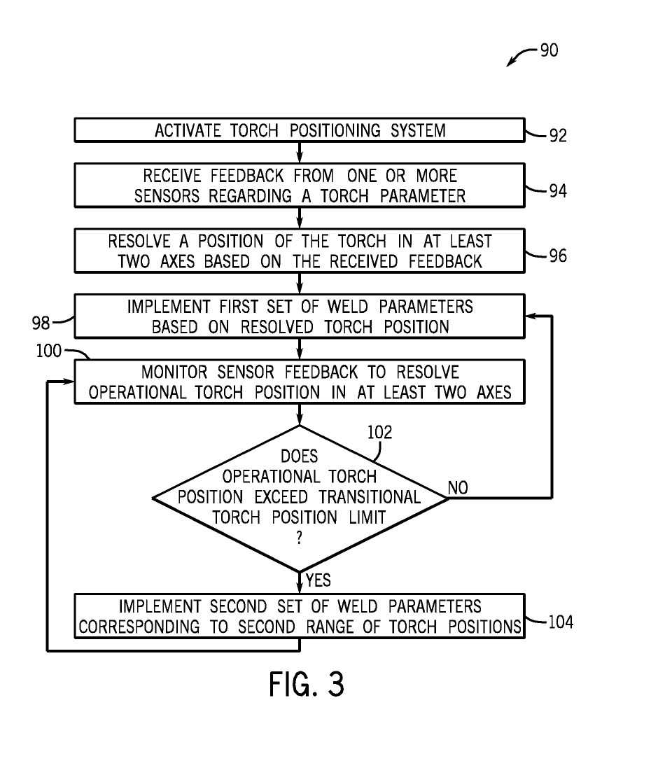

FIG. 3 illustrates a method 90 that may be employed by a controller of the system of FIG. 1 to operate the illustrated sensor system in accordance with an embodiment of the present invention. The method 90 includes the steps of activating the torch positioning system (block 92) and receiving feedback from one or more sensors of the sensor system regarding a torch parameter relating to the torch position (block 94). For example, the controller may receive feedback from an accelerometer located on the body of the torch that is capable of measuring the magnitude and direction of torch acceleration during the welding operation. Based on such feedback, the controller is further configured to resolve a position of the torch in at least two axes (block 96) and to implement a first set of weld parameters corresponding to the resolved torch position (block 98). For example, in one embodiment, the controller may resolve the torch position to determine that the torch is positioned for in-position welding and may implement weld parameters appropriate for an in-position weld.

Further, the controller continues to monitor feedback from the sensor system to resolve the operational torch position in at least two axes throughout the weld operation (block 100). That is, the controller may detect changes in the torch position by continually monitoring sensor feedback. The method 90 also includes checking if the resolved operational torch position exceeds a transitional torch position limit (block 102), for example, as set by an operator before the weld operation began. If the transitional point has not been reached, the controller continues to monitor the torch positional feedback (block 98). However, if the transitional point has been reached or exceeded, the method 90 calls for implementation of a second set of weld parameters corresponding to a second range of torch positions (block 104), for example, torch positions corresponding to out-of-position welding.

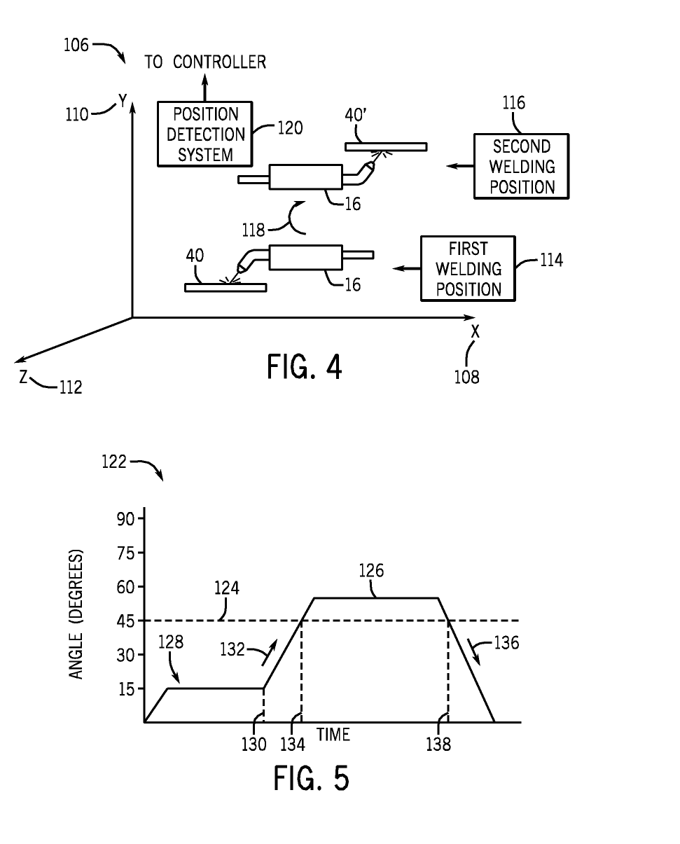

FIG. 4 illustrates an exemplary weld operation being performed in a multi-axis positional system 106 in which the position of the welding torch 16 is altered during welding. As illustrated, the positional system 106 includes an x-axis 108, a y-axis 110, and a z-axis 112. In presently contemplated embodiments, one or more parameters of the position of the welding torch 16 may be resolved based on feedback regarding the position of the welding torch 16 in at least two axes. That is, in many embodiments, the coordinates of the welding torch may not need to be resolved to determine the type of weld being performed; only a parameter of the welding torch position may be resolved in such embodiments. For example, in one embodiment, the controller may be configured to resolve the angular orientation of the welding torch 16 in the x-axis 108, the y-axis 110, and the z-axis 112 based on feedback regarding the actual position of the welding torch 16 in only two of the three axes. As such, in certain embodiments, the controller may utilize positional information to resolve the angular orientation of the welding torch, which may be used as an indication of the type of welding being performed (e.g., horizontal, vertical, overhead, etc.).

In the illustrated embodiment, the welding torch 16 is rotated by the welding operator from a first welding position 114 to a second welding position 116. When positioned in the first welding position, the welding torch 16 is utilized to perform an in-position or horizontal weld on workpiece 40. However, when rotated to the second welding position 116, as indicated by arrow 118, the welding torch is appropriately positioned to perform an out-of-position or overhead weld on workpiece 40′. During the rotation shown by arrow 118, a position detection system 120 measures one or more parameters indicative of the position of the welding torch 16 and communicates the measured parameters to the controller. The controller may then identify when the welding torch 16 reaches and/or exceeds a transition point, such as an angular orientation transition point, as shown in plot 122 of FIG. 5.

It should be noted that although the embodiment of FIG. 4 illustrates a transition between horizontal and overhead welding, the controller may be configured to distinguish between other types of welds based on feedback regarding the position of the welding torch. For example, in other embodiments, the controller may distinguish between vertical and horizontal welding or between vertical and overhead welding. Indeed, in some embodiments, the controller may be configured to switch between multiple weld settings configured for use with multiple processes as the angular orientation of the welding torch is altered within the welding environment.

The plot 122 of FIG. 5 illustrates a predefined transition point 124 equal to 45° at which the controller may switch between a first set of weld parameters (e.g., corresponding to horizontal welding) and a second set of weld parameters (e.g., corresponding to overhead welding). As shown, a resolved positional plot 126 shows motion of the torch, for example from 0° to 15° during a horizontal weld, an indicated by portion 128 of the plot 126. At time 130, the welding torch is rotated from a horizontal position to a position suitable for overhead welding, as indicated by arrow 132. At time 134, the resolved welding torch position reaches the transition point 124, and the controller may alert the operator to the transition and/or may switch to a second set of weld parameters appropriate for the overhead weld. When the welding torch is again rotated, as indicated by arrow 136, and reaches the transition point 124 at time 136, the controller may switch back to the first set of weld parameters. That is, the controller may be configured to monitor the direction of the positional change as well as the presence of a positional change. Further, it should be noted that the welding operation during which the position of the torch is monitored and/or resolved may include welding and non-welding periods, for example, the period between time 130 and time 134.

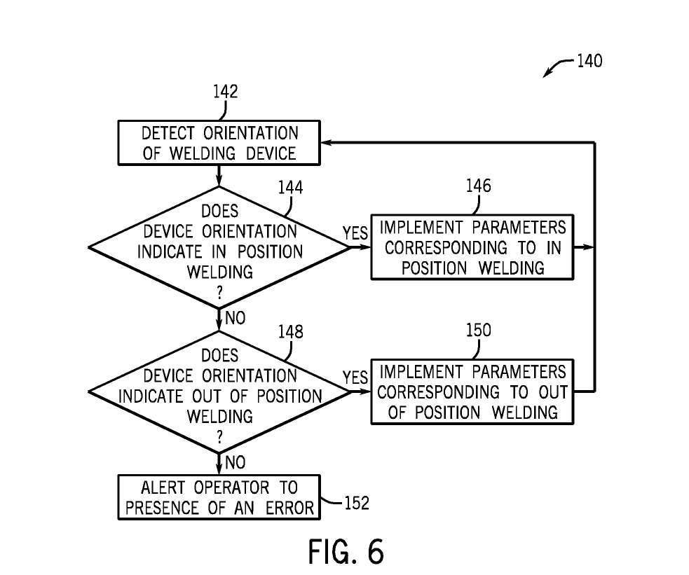

FIG. 6 illustrates a method 140 that may be utilized by the controller in an exemplary welding system in which in-position and out-of-position welding is performed. The method 140 includes detecting the orientation of the welding device (block 142), for example, by monitoring received sensor feedback. The method 140 further includes checking if the device orientation indicates in-position welding (block 144). If the device orientation does indicate in-position welding, parameters corresponding to in-position welding are implemented (block 146). For example, in some embodiments, the current setting of the welding operation may be set to an increased level as appropriate for the given application when the welding device is in a position suitable for a flat weld as opposed to a position suitable for an overhead weld. If the device orientation does not indicate an in-position weld, the controller checks if the orientation indicates an out-of-position weld (block 148) and, if so, implements parameters corresponding to out-of-position welding (block 150). Alternatively, if the device position does not correspond to in-position or out-of-position welding, the operator is alerted to the presence of an error (block 152). For example, such an instance may occur when one or more sensors of the sensor system are malfunctioning.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A welding system, comprising:
a welding power source comprising power conversion circuitry configured to receive primary power and to convert the primary power to a weld power output for use in a welding operation;
a position detection system comprising at least one sensor configured to measure a parameter of a welding device indicative of a position of the welding device during the welding operation; and
a controller communicatively coupled to the position detection system and configured to receive feedback from the position detection system regarding the position of the welding device during the welding operation, to identify when the position of the welding device reaches a predefined transition point, and to control the welding power source to operate within a first set of weld parameters when the position of the welding device has not reached the predefined transition point and to operate within a second set of weld parameters when the position of the welding device reaches the predefined transition point.

2. The welding system of claim 1, wherein the predefined transition point comprises a preset angle corresponding to a direction of rotation of the welding device.

3. The welding system of claim 2, wherein the preset angle is between approximately 0° and approximately 90°.

4. The welding system of claim 1, wherein the at least one sensor comprises an accelerometer configured to measure a magnitude and direction of the acceleration of the welding device.

5. The welding system of claim 1, wherein the first set of weld parameters corresponds to a set of parameters suitable for welding in position, and the second set of weld parameters corresponds to a set of parameters suitable for welding out of position.

6. The welding system of claim 1, wherein the controller is configured to identify when the position of the welding device reaches a predefined transition point via hysteresis by comparing presently received feedback from the position detection system to previously received feedback from the position detection system.

7. A welding system, comprising:
a welding device configured to be utilized in a welding operation to establish a welding arc;
a position detection system configured to measure a parameter indicative of a position of the welding device; and
a controller configured to receive feedback from the position detection system regarding the position of the welding device in at least two axes and to selectively transition control of the welding system between a first set of operational parameters and a second set of operational parameters based on changes in the received feedback during a welding operation.

8. The welding system of claim 7, wherein the welding operation comprises periods in which a welding arc is established between the welding device and a workpiece and periods in which a welding arc is not established between the welding device and the workpiece.

9. The welding system of claim 7, wherein the welding device comprises at least one of a welding torch and a plasma torch.

10. The welding system of claim 7, wherein the first set of operational parameters is suitable for in position welding and the second set of operational parameters is suitable for overhead welding.

11. The welding system of claim 7, wherein the position detection system comprises a visual detection system comprises one or more optical devices configured to track the movement of the welding device.

12. The welding system of claim 7, further comprising a wire feeder configured to supply wire to the welding device.

13. The welding system of claim 7, further comprising a welding power supply configured to supply power to the welding device for establishing and maintaining the welding arc.

14. The welding system of claim 7, wherein the controller is further configured to resolve the angular orientation of the welding device based on the positional feedback from the position detection system regarding the position of the welding device in at least two axes.

15. The welding system of claim 7, wherein the position detection system is configured as a retrofit module configured to be coupled to the welding device and to communicate with the controller via a wireless link.

16. A controller for a welding system, configured to:
receive feedback regarding a position of a welding device;
resolve a position of the welding device in a planar coordinate system comprising at least two axes based on the received feedback;
monitor the position of the welding device in the planar coordinate system during a welding operation; and
indicate to at least one of a welding power source and an operator when the position of the welding device reaches a predefined transition point.

17. The controller of claim 16, wherein the controller is disposed in a welding wire feeder.

18. The controller of claim 16, further configured to alter one or more weld parameters when the position of the welding device reaches the predefined transition point.

19. The controller of claim 16, wherein the predefined transition point comprises an angle corresponding to an overhead welding position.

20. The controller of claim 16, wherein the received feedback comprises a magnitude and direction of acceleration of the welding device.

21. The controller of claim 16, wherein indicating when the position of the welding device reaches a predefined transition point comprises activating an indicator on a control panel, activating an indicator on a welding helmet, activating an indicator on a welding torch, or alerting a second welding device.
